(19) United States
(12) Patent Application Publication
(10) Pub. No.: US 2025/0303464 A1
(43) Pub. Date: Oct. 2, 2025

(54) METHOD AND DEVICE FOR MOLDING A HARDENABLE MOLDING COMPOUND

(71) Applicant: TECHNISCHE UNIVERSITÄT MÜNCHEN, Müunchen (DE)

(72) Inventors: Wolfram VOLK, Erding (DE); Daniel GÜNTHER, München (DE); Steffen KLAN, Freising (DE); Patricia ERHARD, Garching (DE); Christoph HARTMANN, München (DE); Philipp LECHNER, München (DE); Florian STEINLEHNER, München (DE)

(21) Appl. No.: 18/864,746

(22) PCT Filed: May 12, 2023
(86) PCT No.: PCT/EP2023/062851

§ 371 Date: Nov. 11, 2024

(30) Foreign Application Priority Data
May 16, 2022 (EP) 22173609.3

(51) Int. Cl. B22D 17/00; B22D 17/22

(52) U.S. Cl. CPC B22D 17/002; B22D 17/22

(57) ABSTRACT

A method for molding a hardenable molding compound may comprise containing a hardenable molding compound in a cavity. The hardenable molding compound may be in a fluid state and the cavity may be delimited by a first mold part and at least one second mold part of a molding tool. After a defined period of time for heating the first mold part and the second mold part by the molding compound, the method may further comprise generating at least a first relative movement between the first mold part and the second mold part so that the cavity becomes smaller while forming one or more thin-walled regions. The one or more thin-walled regions having a material thickness of not more than 5 mm. The method may further comprise allowing the molding compound to harden.

The invention relates to a method and a device for molding a hardenable molding compound. This allows the manufacture of a component, in particular by means of primary molding.

It is known that hardenable molding compounds can be brought into any desired shape by using a molding tool and being allowed to harden in this shape or, in other words, to solidify or amalgamate. In this way, a component can be produced in a desired shape from the initially amorphous molding compound. This can also be referred to as a primary molding of the component.

Casting is a typical method in primary molding. In this case, the molding compound is filled into a molding tool in which it solidifies and from which it can afterwards be removed. Various casting methods exist that differ, for example, in the type of molding tool, the molding compounds, and/or the way in which the molding compound is filled into the molding tool.

One disadvantage of previous casting methods is that the desired components and, in particular, component sizes cannot always be produced in the desired quality. This applies in particular to components with thin-walled regions. Within the context of the present disclosure, thin-walled regions can generally be understood as areas with a material thickness of up to 3 mm or even up to 5 mm. In such thin-walled regions, there is a risk of so-called cold laps occurring in the casting process. This can be understood to mean that parts of the molding compound harden prematurely, for example while the molding compound is still being filled and before achieving an intended positioning within the molding tool.

As a result, the minimum wall thickness is generally dependent on the method used to manufacture the casts and the material of the molding compound, but not on the function of the component. The closer one gets to the method-specific minimum possible wall thickness, the greater the process-related rejections.

In addition, various metal alloys with inherently advantageous properties cannot be processed into thin-walled products. Examples include wrought aluminum alloys and steels. Problems also occur with plastics when filling molding tools with thin-walled regions, especially when using highly viscous moulding compounds. In addition, not all polymers are reliably workable (e.g. Teflon). With ceramic pressure-slip casting, problems occur in the form of premature water removal and solidification and the achievable material structure is often not very dense. Due to its low flowability, concrete can only be used as a molding compound for thick-walled components. It is also often difficult to form-fill concrete when combined with reinforcing rods.

As a result, potential component design for manufacture has to date been limited or complex additional measures are required to limit the risk of cold laps, for example. These additional measures can include, for example, specially designed gate systems that maintain a high proportion of fluid molding compound near the thin-walled regions. Thermally insulated and/or heated molds can also be used. Die casting methods can also be used. However, the achievable component sizes are limited and filling the moulding compound under pressure can cause turbulence and air inclusions in the melt, thus impairing the quality of the metal structure. Cores for creating hollow structures cannot be used in die casting.

The object of the present invention is therefore to improve the manufacture of components from a hardenable molding compound and in particular of components with thin-walled regions, in particular with regard to costs, effort and/or quality.

This object is achieved by the subject matter of the accompanying independent claims. Advantageous embodiments are given in the dependent claims and in this description.

Accordingly, a method for molding a hardenable molding compound is proposed, which includes:
Containing (or, in other words, arranging) a hardenable molding compound, which is in a fluid and in particular in a fluid or molten state, in a cavity delimited by a first mold part and at least one second mold part of a molding tool;
Generating at least a first relative movement between the first and second mold part, so that the cavity becomes smaller, in particular where the molding compound is at this stage still fluid;
Allowing the molding compound to harden, which may in particular involve allowing the expiry of a defined period of time during which the mold parts are not moved and/or the cavity is not changed.

This procedure differs from known casting methods insofar that the size of the cavity into which the molding compound is filled varies and, in particular, becomes smaller when the molding compound has not yet hardened. The cavity in the prior art does not vary in this way after the fluid molding compound has been poured in, but stays the same until the molding compound has solidified. The molding tool is then opened to enable removal of the finished component, i.e. the cavity is enlarged and dissolved.

In accordance with the invention, on the other hand, it has been recognized that the proposed procedure enables heating of the mold parts by the molding compound after having been filled into the cavity or into at least one of the mold parts (see below). Only then does the cavity become smaller and the wall thicknesses or also the volume of the cavity, and thus the still fluid molding compound contained therein, is locally reduced, in particular when forming thin-walled regions of the type disclosed herein. However, as the mold parts in this state have already been heated to a certain extent by the previously absorbed molding compound, they extract only limited heat from the molding compound. This means that those parts of the molding compound located in thin-walled regions of the cavity harden more slowly, which reduces the risk of cold laps.

Furthermore, regardless of the risk of cold laps (i.e. even when molding compounds at room temperature, such as concrete), reliable and high-quality forming of thin-walled regions can be achieved by means of the disclosed relative movement. In accordance with the invention, for example, the molding compound can enter the thin-walled regions in a less turbulent manner, but rather in a laminar and/or uniform manner which, in contrast to previous die casting methods, avoids casting defects.

Reducing the cavity as a result of the first relative movement can involve reducing the volume of the cavity. The cavity and thus the molding compound contained therein can thus achieve a so-called target geometry. Additionally or alternatively, a distance between at least one pair of opposing areas of the mold parts can be reduced by means of the first relative movement (for example, viewed along an axis of movement of the first relative movement). This can also be accompanied by a reduction in the size of the cavity, in particular a reduction in a dimension of the cavity corresponding to this distance.

The cavity can define the shape of the component for manufacture. The mold parts can together define or, in other words, limit a volume and/or a surface area of the cavity by at least 80% or at least 90%. Each of the mold parts can define or limit at least 15% or at least 25% of the volume and/or the surface of the cavity. No movable parts delimiting the cavity are provided, except for the mold parts. Otherwise, these movable parts can only delimit a correspondingly small proportion of the surface area and/or volume of the cavity. For example, they can only be provided for a locally limited pressing of molding compound into the cavity otherwise delimited by the first and second mold part. Such a movement of a further part cannot be included in the first and second relative movements of the mold parts disclosed herein.

Containing the molding compound into the cavity can comprise:
Filling the molding compound into the cavity delimited by the first and second mold parts or, in other words, filling the molding compound into the molding tool when the first and second mold parts are already arranged in such a way that the cavity is formed (at least in an enlarged initial state or also as a pre-cavity).

Alternatively, this can include containing the molding compound in the cavity:
Filling the molding compound into the molding tool in an open state and relatively arranging the first mold part and second mold part to form the cavity, which contains the (already filled) molding compound.

In the open state, the first and second mold parts can be lifted off one another, in particular in such a way that they do not jointly delimit any wall area of the cavity and/or that the mold parts generally do not touch one another.

Accordingly, in this case, the molding compound can be filled into just one of the mold parts, for example into a recess present there. The mold parts can then be arranged relative to each other in such a way to form the cavity and the already filled molding compound is contained between these and the cavity.

One further development provides that the first relative movement is only generated when the entire molding compound is contained in the cavity. For example, a defined volume of molding compound may be required to manufacture a certain component. Only when this has been completely filled into the molding tool and consequently contained in the cavity, can the cavity be made smaller (in particular by defining thin-walled regions) by means of the first relative movement. This increases the extent to which the mold parts are heated by the incorporated molding compound.

In principle, it is possible to fill the molding compound into the molding tool in such a way that (in particular exclusively) laminar flows are created within the molding compound. A suitable filling speed for the molding compound can be selected for this purpose, for example,

According to one variant, the molding compound is filled into the molding tool by Gravity Die Casting. Alternatively, the molding compound can be filled into the molding tool by die casting or low-pressure casting. In this context, the pressure applied for filling can be at least partially maintained or increased (e.g. by at least 10%) when generating the first relative movement. This can reduce turbulence within the molding compound.

On the other hand, to avoid turbulence, any pressure placed on the molding compound during the first relative movement and/or as a result thereof (and In particular independently of any method used to fill the molding compound) may not be increased by more than 25% or not even more than 10% or it may essentially remain constant. It can be assumed that at least atmospheric pressure or a defined negative pressure acts on the molding compound before the first relative movement is generated.

After completion of the first relative movement, there may still be a fluid connection from inside the cavity to the outside (in other words, to an area outside the cavity). For example, a fluid connection to an overflow area for any molding compound displaced from the cavity and/or a fluid connection of the cavity to the outside can be maintained via a vent hole. This limits any pressure increases within the molding compound.

The first relative movement can set the molding compound in motion under essentially laminar flow conditions and, in particular, force it laminarly into the thin-walled regions. To do this, for example, a force and/or a movement speed of the first relative movement can be appropriately selected. In particular, the first relative movement can essentially be force-free. This can be understood to mean that a force to generate this relative movement is limited in such a way that the movement can be achieved with it (e.g. by overcoming inertial or frictional forces), but no force significantly exceeding this affects the molding compound, which would be required, for example, for a significant (e.g. more than 20 percent) and/or permanent increase in the pressure of the molding compound.

In general, no pressure casting can occur before and/or during or after the first relative movement. The molding compound can be subjected to pressures of more than 0.2 MPa or even more than 1 MPa in at least one and preferably in none of the aforementioned states.

After the first relative movement and, optionally, after allowing the molding compound to harden, one embodiment provides for the following:
Applying a closing force to at least one of the first and second mold parts, whereby the infeed force presses the mold parts against each other.

Between the first relative movement and applying the closing force, one may have to wait for a defined period of time, e.g. at least 2 seconds but preferably no more than 60 seconds or generally not until the molding compound begins to solidify. The cavity can be left in its reduced state, which is achieved as a result of the first relative movement, during this time period. This can be done by applying appropriate holding forces or even without any force. The closing force can correspond to a subsequent increase (in particular a renewed increase) in a force applied to at least one of the molded components. This additional closing force allows the molding compound to be brought into a final shape with improved accuracy. Additionally, it has been shown that this can improve the material structure, for example by achieving preferred grain sizes in metallic molding compounds.

Optionally, the closing force can be used to generate a further relative movement between the first and second mold part, by means of which the cavity is reduced in size, in particular further reduced in size based on the state after the first relative movement. This reduction in size can be smaller than with the first relative movement. For example, the reduction in size can be less than 50% or even less than 10% of that during the first relative movement. This takes account of the fact that the molding compound can no longer be fluid to the same extent as during the first relative movement but has, for example, already solidified, at least in part. After the further relative movement, the cavity and thus the molding compound contained therein may have reached its final target geometry.

Additionally or alternatively, the closing force can only be generated when the molding compound is no longer fluid, at least in some areas. This can mean that the molding compound has already hardened at least partially and/or in some areas. The molding compound may also have hardened completely.

The at least partially hardenen molding compound can thus be formed by means of the closing force, in particular finally formed to produce a final component shape and/or a final material structure.

According to a further aspect, the closing force is at least 10% higher than a force applied to generate the first relative movement. This enables the molding compound to be particularly reliably and precisely shaped by means of the closing force. The closing force and the force applied to generate the first relative movement can be generated by means of the same movement device, which simplifies the method and a device used for this purpose.

The molding tool can form a lost mold (i.e. a mold destroyed as a result of the casting process) or a permanent mold. Particularly in the case of a lost mold, relative movements of mold parts have been unusual up to now, so that thin-walled regions cannot be manufactured with the reliability achievable according to the invention.

According to one variant, one of the mold parts is a lost mold part and the corresponding other of the mold parts is a permanent mold part. This can be provided in particular in any variant disclosed herein, in which a further relative movement takes place while generating an closing force. The lost mold part increases the degree of freedom in shaping, as the component can be removed by destroying this mold part. In particular, there is a greater degree of freedom with regard to arranging overflow areas or collection cavities. These can, for example, be arranged outside a parting plane of the mold parts and, in particular, completely inside the lost mold part. As only one of the mold parts (namely the lost mold part) needs to be manufactured anew before each casting process, however, the effort can be limited by providing the additional mold part as a permanent mold part.

One further development of the method also provides for:
Discharging a portion of the molding compound from the cavity during the first relative movement (and/or during any further relative movement, for example as a result of applying the above closing force), i.e. discharging that portion of the molding compound which is forced out of the cavity becoming smaller in size.

This enables significant travel paths within the scope of the relative movements and significant reductions in the cavity size. The cavity can initially be defined with a correspondingly large volume to accommodate a large volume of molding compound to effectively heat the mold part.

In this context, it is possible that the discharging comprises at least one of the following:
Discharging the molding compound portion into at least one collection cavity, which is delimited by at least one of the mold parts. The collection cavity can, for example, be at least partially unfilled beforehand and/or cannot define a constituent part to be retained in the component to be manufactured (i.e. the molding compound that solidifies there can subsequently be removed from the component). The collection cavity can also be referred to as an overflow. Alternatively or additionally, general overflow areas can be provided within the molding tool.
Discharging the portion of the molding compound via a filler channel used to fill the molding compound. This can include, for example, forcing the portion of the molding compound back into a molding compound reservoir connected to the filler channel and/or into a melt generator connected to the filling channel and/or into a gating system connected to the filling channel.
Discharging the molding compound via a (fluid) channel, which is formed or opened by destroying a defined region of the molding tool. For example, at least one of the mold parts or the molding tool in general can comprise at least one predetermined breaking point that breaks in a defined manner as a result of pressure exerted by the molding compound. This predetermined breaking point can form the defined area of the molding tool that is broken open and thus destroyed. This defined area and/or the predetermined breaking point can be, for example, a wall area of a lost mold with locally reduced material thickness. This wall area can separate the cavity from a discharge channel and can be penetrated by the molding compound, thus creating a fluidic connection between the cavity and the discharge channel. The pressure effect of the molding compound can be increased beyond a threshold value as a result of the first or any further relative movement of the mold parts, whereupon the predetermined breaking point breaks.

In a further development, at least one core is arranged in the cavity, which is embedded in the molding compound. At least one of the mold parts, in particular one that is actively moved during the first or any further relative movement, can be movable relative to the core. The core can be generally stationary. For example, the core can be positioned within the cavity via rods or bars, whereby at least one (in particular actively moved) mold part is movable relative to the core. In this context, the mold part can also be penetrated by the rods or webs. For example, these can protrude into the cavity through recesses within the mold part.

The invention also relates to a device for molding a hardenable molding compound, comprising, inter alia:
a molding tool, comprising a first mold part and at least one second mold part, which together define a cavity in which a hardenable molding compound can be contained;
a movement device which is set up to generate a relative movement between the first and the second mold part;
a control device which is configured to control the movement device in generating at least a first relative movement, which reduces the size of the cavity, between the first and the second mold part when the cavity is at least partially filled with the hardenable molding compound.

The device may be configured to perform a method according to any variant disclosed herein. In particular, the control device can be set up to initiate any required measures and/or to carry out any necessary activation.

Further optional features and specific embodiments of general features of the method and device disclosed herein are explained below. These features and embodiments can be provided in any number and combination.

For example, according to one general aspect, the molding tool and/or the mold parts may comprise at least one of the following materials: Plastic, wood, ceramic, glass, glass-ceramic, concrete, cement, plaster, composites and/or composite materials, sand/binder mixtures, molding sand, metal, steel, especially hot-working steel.

The molding tool and/or its components can be unheated or heatable (i.e. temperature-controlled). The latter can be achieved by means of at least one of the following variants: Hot air preheating, radiation heating, convective heating, heat conduction, electrical heating via resistance heating, electrical heating via induction, electrical heating via current heating, near-contour heating/cooling via heating/cooling loops, temperature control with water, temperature control with oil, temperature control with fluid metals, heating via chemical reactions.

The number of mold parts is not limited to two, i.e. the molding tool is not necessarily limited to two mold halves formed by the mold parts. Instead, a higher number of mold parts can be provided. In general, the mold parts can include mold inclines and/or roundings.

The forming tool can comprise at least one of the following as at least one of the forming parts or also as an additional tool component: a ram, a die, a hold-down clamp, a slide, an undercut mold part and/or an undercut tool component, a mandrel, a core.

The molding tool can comprise at least one of the following features, in any number, whereby these features can also be referred to as auxiliary parts of the tool: a pouring channel, a vent duct, an overflow area, an ejector pin, a guide or guide structure, a temperature sensor, a pressure sensor, a material detector, a hot runner, a seal, a valve to control the flow of the molding compound, a predetermined breaking point and/or a diaphragm, an overflow or return Guide structure, a temperature sensor, a pressure sensor, a material detector, a hot runner, a seal, a valve for flow control of the molding compound, a predetermined breaking point and/or a diaphragm, an overflow or return resistance (e.g. comprising a geometric flow resistance, a cross-sectional transition, a porous structure; a specifically induced cold lap; an extended flow path; a roughening).

The working direction of the mold parts can be linear and/or can comprise only one direction of movement. Alternatively, several working directions and/or complex movements can take place in several successive working directions.

The molding compound may comprise at least one of the following materials:
thermoplastic, thermoset, fiber-reinforced composites, a ceramic casting compound, gypsum, concrete, in particular ultra-high performance concrete (UHPC), polymer concrete, metal, e.g. magnesium, aluminum, copper, zinc, tin, iron, nickel, lead, titanium and their alloys, wrought aluminum alloy, cast iron, steel.

The material infeed, or in other words, filling the molding compound, can be carried out according to one of the following variants: the mold parts can be completely immersed in the fluid molding compound and closed there; gravity casting into the open molding tool can be performed; one of the mold parts can comprise a filler channel, in particular a mold part formed as a ram, which is moved into a mold part formed as a die; a lateral hot channel can be provided; the molding compound can be fed from below vertically through one of the mold parts and in particular through a mold part designed as a die using the low-pressure principle; the molding compound can be contained in the cavity and only then heated and in particular melted there.

Additionally or alternatively, any of the following auxiliary agents may be used, alone or in any combination: Grease or lubricants, release agents, coatings for chemical protection, coatings for adapting the heat transfer, coatings for modifying the surface layer composition/grain morphology.

Examples of embodiments of the invention are explained below with reference to the accompanying schematic figures. Similar or similarly acting features can be provided with the same reference symbols across all figures.

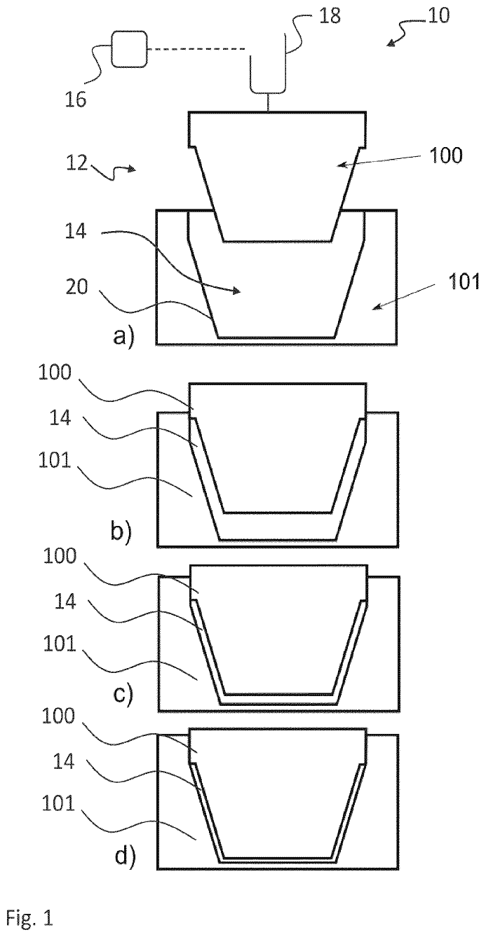

FIG. 1 shows operating states a)-d) of a device according to a first embodiment example, which performs a method according to a first embodiment example.

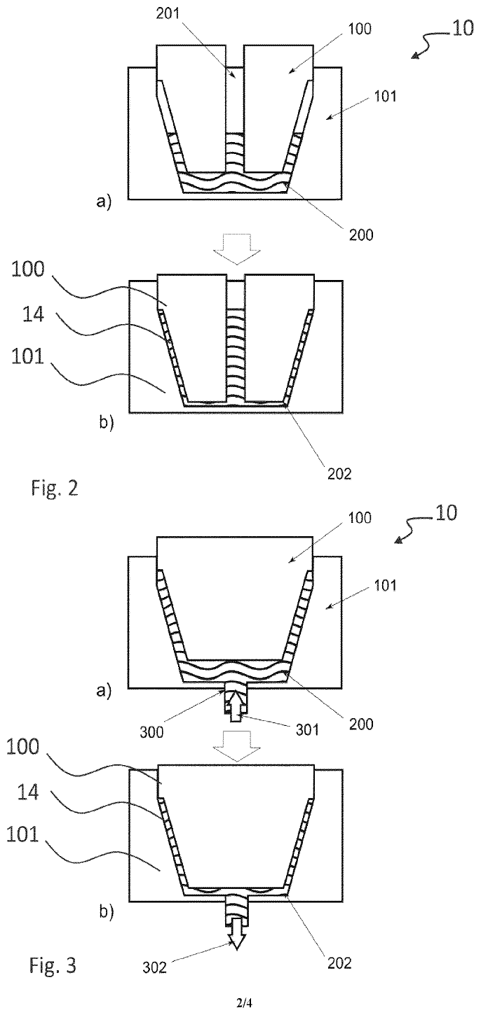

FIG. 2 shows operating states a)-b) of a device according to a second embodiment example, which performs a method according to a second embodiment example.

FIG. 3 shows operating states a)-b) of a device according to a third embodiment example, which performs a method according to a third embodiment example.

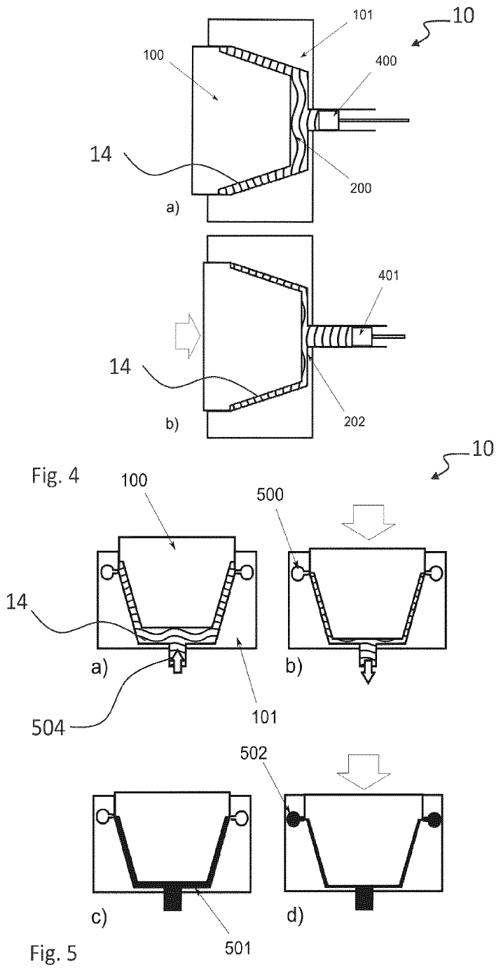

FIG. 4 shows operating states a)-b) of a device according to a fourth embodiment example, which performs a method according to a fourth embodiment example.

FIG. 5 shows operating states a)-d) of a device according to a fifth embodiment example, which performs a method according to a fifth embodiment example.

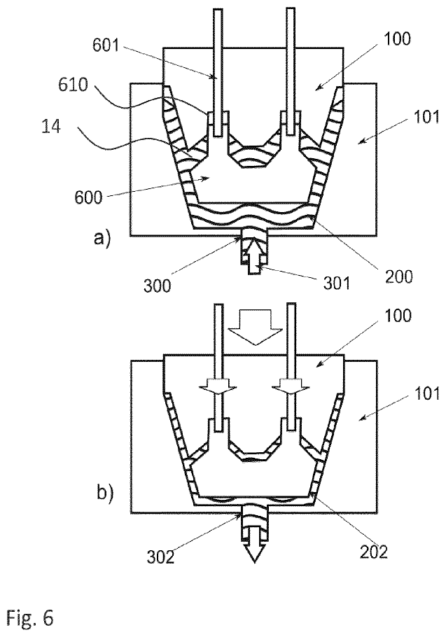

FIG. 6 shows operating states a)-b) of a device according to a sixth embodiment example, which performs a method according to a sixth embodiment example.

FIG. 1 shows a device 10 comprising a molding tool 12. The molding tool 12 has two mold parts 100, 101. One molded part 100 is designed as a ram and another mold part 101 is designed as a die. The molding tool 12 can be designed as a lost mold, for example made of sand, or as a die.

The mold part 101 is stationary. The mold part 100 is movable. For this purpose, it is mechanically coupled to a schematically illustrated direction of movement 18, in particular to an actuator of the movement device 18, for example a hydraulic cylinder.

The device 10 also comprises a control device 16, for example a computer and/or comprising at least one processor. The control device 16 is set up to control the direction of movement 18 via a wired or wireless data connection, shown in dashed lines, so that the mold part 100 is moved as required.

The control device 16 and the direction of movement 18 are only shown in state a) but are also present in the other states b)-d). The control device 16 and the direction of movement 18 are also not shown in the devices 10 as presented in FIGS. 2-6, but are nevertheless present.

The mold part 101 has a recess 20 into which the molded part 100 can be moved. The space between this recess 20 and an opposite surface of the component 100 that can be moved into it forms a cavity 14 for containing a molding compound not shown.

FIG. 1 shows the successive operating states a)-d), each of which corresponds to method steps of the method carried out by the device 10.

In state a), the molding tool 12 is shown in an open state. Mold part 100 has clearly moved out of the recess 20 of the mold part 101 and the cavity 14 is not completely enclosed by the mold parts 100, 101 or, in other words, not completely defined by them. In this state, the cavity 14 can be described as open, dissolved or not yet fully formed.

For example, in gravity casting, a molding compound not shown is filled into the recess 20 in a fluid and, in particular, molten state. The molding compound is heated to a temperature above room temperature, for example to over 100° C. The molding compound may comprise any material example disclosed herein and may in particular be a molten metal.

In state b), the mold part 100 has been partially lowered into the recess 20 of the mold part 101 by means of the direction of movement 18. As a result, the cavity 14 is formed and/or is completely enclosed by the mold part 100, 101 and completely defined between them. This can be described as forming an enlarged pre-cavity. The molding compound, which is not shown, completely fills the cavity 14 and thus heats the mold parts 100, 101. Features known to the skilled person, such as vent holes, which allow the molding compound to be enclosed by means of the mold parts 100, 101 are not shown.

The mold part 100 is then lowered further to reach state c). It should be noted that, starting from state a), lowering the mold part 100 can occur as part of a continuous first relative movement. This first continuous relative movement can include state b) as an Intermediate stage and end with state d), in which a target geometry is reached. In this case, state c) represents an intermediate stage, which can also be described as achieving a pre-geometry.

However, a first relative movement of the type disclosed herein (in particular a continuous relative movement) can also only occur as of state b). For example, after reaching state b), one can wait a defined period of time for the mold parts 100, 101 to heat up.

In state c), the cavity 14 is significantly smaller than in state b), i.e. the volume of the cavity 14 has decreased. This reduction in size is also achieved by forming thin-walled regions, as the distances between the mold parts' 100, 101 opposing regions and surfaces are reduced. These thin-walled regions can have material thicknesses of no more than 5 mm or no more than 3 mm. In other words, such thin-walled material thicknesses can be formed or predetermined by the cavity.

In state c), the molding compound, which is still fluid, penetrates into the thin-walled regions without forming cold laps and fills them completely. This takes place under laminar flow conditions, which, for example, significantly increases the quality of the cast product compared to turbulent die casting.

During the transition from state b) to state c), excess molding compound flows back into a filler channel not shown. As mentioned, reducing the size of the cavity 14 when the molding compound is still fluid up to the state d) where this can be continued (i.e. until the target geometry has been achieved) before the molding compound solidifies.

In summary, starting from state b) (pre-cavity) and running through state c) (pre-geometry), state d) (target geometry) can be achieved in a continuous relative movement and only then can the molding compound harden.

Alternatively, starting from state c), state d) can only then be approached after a defined period of time has elapsed. Within this period of time, the molding compound begins to harden at least partially and/or in certain areas and is therefore no longer completely fluid. A closing force is then generated by means of the direction of movement 18, which pushes the mold part 100 further into the recess 20 of the mold part 101 to reach state d). The already partially or completely solidified molding compound is thereby formed into a final component geometry. In such a case, in order to withstand the closing force, the molding tool 12 is advantageously designed as a permanent mold.

Finally, a change can be made to state a) or to an even more open state (not shown) of the molding tool 12 in order to remove the component formed from the hardened molding compound from the molding tool 12.

FIG. 2 shows a modification of the first embodiment, wherein a filler channel 201 is formed in the first mold part 101 to perform a gravity casting method. State a) in FIG. 2 largely corresponds to state b) in FIG. 1 (pre-cavity) and shows the initial filling of a molten molding compound 200 through the filler channel 201. As a result, the mold parts 100, 101 are heated by the molding compound 200.

State b) in FIG. 2 corresponds to a target geometry in accordance with state d) from FIG. 1 and is achieved by a relative movement of the mold part 100 into the mold part 101 (see movement arrow in state b)). The cavity 14 defined between these mold parts 100, 101 becomes smaller, forming thin-walled regions. The molding compound, which is still fluid, penetrates into these under laminar flow conditions along the heated adjacent surfaces of the mold parts 101, 100 without any casting defects.

FIG. 3 shows a process similar to FIG. 2, but for low-pressure casting. In this case, the molding compound 200 is filled from vertically below through a filler channel 300 into the cavity 14 between the mold parts 100, 101 in accordance with the low-pressure casting method known per se. In other words, the molding compound 200 rises under pressure into the cavity 14, see flow direction 301. The mold parts 100, 101 can form a permanent mold and be made of hot-work steel, for example.

In state a) (pre-cavity), to achieve heating of the mold parts 100, 101, the molding compound then fills the cavity 14 at least partially and in particular completely. The molded part 100 is then lowered relative to the mold part 101 (see movement arrow in state b), which corresponds to a target geometry). The cavity 14 then becomes smaller, forming and filling thin-walled regions with the still fluid molding compound 200. Excess molding compound 200 is forced back out of the cavity 14 into the filler channel 300, see flow direction 302.

Optionally, analogous to state d) from FIG. 1, after the molding compound has hardened, the solidified component can be formed even further by means of an additional closing force, further reducing the size of the cavity 14. In this case, the filler channel 300 can be closed, for example by means of a valve not shown, before the closing force is applied.

FIG. 4 shows a process analogous to FIG. 3, but for a die casting method with lateral feeding of the molding compound 200. More precisely, the molding compound 200 is filled laminarly into the cavity 14 between the mold parts 100, 101 by means of a slide 400 in state a) (enlarged pre-cavity) and heats the mold parts 100, 101.

In state b) (target geometry), due to the movement of the mold part 100 into the molded part 101 (see movement arrow), the cavity 14 becomes smaller. Excess molding compound is forced out of the cavity 14 by forcing back the slide 401.

FIG. 5 shows a device 10 in which the stationary mold part 101 comprises at least one collection cavity 500 (for example formed as a circumferential ring). The collection cavity 500 can also be referred to as an overflow.

In state a) (pre-cavity), the molding compound is filled via a filler channel 504 using the low-pressure method analogous to FIG. 4 and increases in the cavity 14 (see flow direction indicated by arrow). It then heats the mold parts 100, 101. In state b) (pre-geometry), the mold part 100 is lowered into the mold part 101, forcing excess molding compound out of the cavity 14 (see flow direction indicated by the arrow below). As indicated by a deviating hatching or filling, the molding compound 501 then begins to solidify and becomes viscous and/or hardens. After a corresponding hardening time has elapsed, a closing force is applied to reach state d) (target geometry), whereby the mold part 100 is lowered further and the cavity 14 is further reduced in size. The molding compound 501 then enters the collection cavity 500, where it forms excess component areas 502, which can then be removed.

In the state of figure d), the filler channel 504 can be closed by means of a valve, not shown, and/or the filler channel 504 can be closed by solidified molding compound.

FIG. 6 shows a variant with an additional core 600 to define a hollow structure in the manufactured component. The mold part 100 has recesses in which rods 601 are inserted. The rods 601 serve as a holding and positioning device to position the core 600 in the cavity 14.

In state a), molding compound 200 is again filled into the cavity 14 via a filler channel 300 using a low-pressure method (see flow direction 301). The molding compound 200 embeds the core 600 or, in other words, encases it.

The core 600 initially has a defined clearance 610 relative to the mold part 100, in particular when viewed along an axis of movement of the mold part 100. By means of this clearance, an extent of movement of the core 600 relative to the mold parts 100, 101 can be adjusted. To achieve state b), the mold part 100 is lowered into the molded part 101 (see movement arrows), relative to the initially fixed rods 601. A movement force is transferred from the mold part 101 to the core 600 only after having bridged the clearance 610, enabling it to be lowered together with the mold part 100.

When state b) is achieved, the target geometry is achieved, in which the cavity 14 is reduced in size and has thin-walled regions. As indicated by the flow arrow 302, excess molding compound can be forced out of the cavity 14 via the filler channel 300.

In the following table, states of a molding compound are entered as a function of positions of the mold parts 100, 101 for embodiments of methods according to the invention. The “open” state corresponds to the state shown in FIG. 1a). The “pre-cavity” state corresponds to a state with an initially enlarged cavity, such as in FIG. 1b).

The “pre-geometry” state corresponds to a cavity that has already been reduced in size compared to the “pre-cavity” but has not yet been definitively reduced, as in the case of FIG. 1c), for example. The “target geometry” state corresponds to a maximum reduced volume of the cavity; see FIG. 1d) as an example.

The following states of the molding compound can be achieved, for example, by selecting suitable time intervals between the individual movement states of the molding tool and/or by selecting the molding compound and/or by selecting its filling temperature.

When pouring into a sand mold (optionally with a moved core package as in FIG. 6), one embodiment shows the following sequence, with “X” indicating the state of the molding compound in the respective state of the molding tool:

| | | | |
|---|---|---|---|
| State molding | Molding | Molding | Molding |
| tool | compound fluid | compound mushy | compound solid |

| | | |
|---|---|---|
| open | X | |
| Pre-cavity | X | |
| Pre-geometry | X | |
| Target geometry | X | |
| Cooling down | | X |

In another exemplary process, which corresponds to a type of thixoforming process by cause of the molding of a pulpy mass, the following method is used. For example, the molding compound is not filled in until the pre-cavity has formed, for example using a low-pressure method:

| State molding | Molding | Molding | Molding |
|---|---|---|---|
| tool | compound fluid | compound mushy | compound solid |
| open | | | |
| Pre-cavity | X | | |
| Pre-geometry | | X | |
| Target geometry | | X | |
| Cooling down | | | X |

In another exemplary process, in which the molding compound already solidifies as soon as the pre-geometry is present and is only then formed into the target geometry by applying a further closing force, the following process occurs. This can also be referred to as cast forging:

| | | | |
|---|---|---|---|
| State molding | Molding | Molding | Molding |
| tool | compound fluid | compound mushy | compound solid |

| | | |
|---|---|---|
| open | X | |
| Pre-cavity | X | |
| Pre-geometry | | X |
| Target geometry | | X |
| Cooling down | | X |

### LIST OF REFERENCE SIGNS

10 Device
12 Molding tool
14 Cavity
16 Control device
18 Movement device
20 Recess
100 Mold part
101 Mold part
201 Filler channel
202 Molding compound
300 Filler channel
301-302 Flow direction
500 Collection cavity
501 Hardened molding compound
502 Excess component area
504 Filler channel
600 Core
601 Rod
610 Clearance

1. A method of molding a hardenable molding compound, the method comprising:
containing a hardenable molding compound, which is in a fluid state, in a cavity delimited by a first mold part and at least one second mold part of a molding tool;
after expiry of a defined period of time for heating the first mold part and the at least one second mold part by the hardenable molding compound, generating at least a first relative movement between the first mold part and the at least one second mold part, so that the cavity becomes smaller while forming one or more thin-walled regions, the one or more thin-walled regions having a material thickness of not more than 5 mm; and
allowing the hardenable molding compound to harden.

2. The method according to claim 1, wherein the first relative movement occurs in such a way that the hardenable molding compound enters the one or more thin-walled regions substantially laminar.

3. The method according to claim 1, wherein the first relative movement occurs while the hardenable molding compound is still in the fluid state.

4. The method according to claim 1, wherein containing the hardenable molding compound comprises:
filling the hardenable molding compound into the cavity delimited by the first mold part and the at least one second mold part; or
filling the hardenable molding compound into the molding tool in an open state and relatively arranging the first mold part and the at least one second mold part to form the cavity containing the hardenable molding compound.

5. The method according to claim 1, wherein the first relative movement is only generated when an entire amount of the hardenable molding compound is contained in the cavity.

6. The method according to claim 1, wherein the hardenable molding compound is filled into the molding tool by at least one of pressure casting or low-pressure casting, and wherein a pressure applied for filling is at least partially maintained or increased when the first relative movement is generated.

7. The method according to claim 1, wherein when the first relative movement is generated, a pressure acting on the hardenable molding compound is increased by not more than 25%.

8. The method according to claim 1, wherein the defined period of time for heating the first mold part and the at least one second mold part is at least 2 seconds.

9. The method according to claim 1, further comprising:
following the first relative movement, applying a closing force to at least one of the first mold part or the at least one second mold part, wherein the closing force forces the first mold part and the at least one second mold part against each other.

10. The method according to claim 9, wherein a further relative movement between the first mold part and the at least one second mold part is generated by the closing force, through which the cavity becomes smaller.

11. The method according to claim 9, wherein the closing force is only generated when the hardenable molding compound is at least regionally no longer fluid.

12. The method according to claim 9, wherein the closing force is at least 10% higher than a force applied to generate the first relative movement.

13. The method according to claim 1, wherein the molding tool forms a lost mold or a permanent mold.

14. The method according to claim 1, wherein one of the first mold part or the at least one second mold part is a lost mold part and the other of the first mold part or the at least one second mold part is a permanent mold part.

15. The method according to claim 1, further comprising:
discharging at least a portion of the hardenable molding compound from the cavity during the first relative movement.

16. The method according to claim 15, wherein the discharging comprises at least one of:
discharging the at least a portion of the hardenable molding compound into at least one collection cavity delimited by at least one of the first mold part or the at least one second mold part;
discharging the at least a portion of the hardenable molding compound via a filler channel used to fill the hardenable molding compound; or
discharging the at least a portion of the hardenable molding compound via a channel that is formed or opened by destroying a defined area of the mold.

17. The method according to claim 1, wherein at least one core is arranged in the cavity and is embedded in the hardenable molding compound.

18. A device for molding a hardenable molding compound, comprising:
a molding tool, having a first mold part and at least one second mold part, which together delimit a cavity in which the hardenable molding compound is to be contained;
a movement device configured to generate a relative movement between the first mold part and the at least one second mold part; and
a control device configured to control the movement device to generate the relative movement between the first mold part and the at least one second mold part, wherein the relative movement between the first mold part and the at least one second mold part reduces a size of the cavity when the cavity is at least partially filled with the hardenable molding compound and after expiration of a defined period of time for heating up the first mold part and the at least one second mold part with the hardenable molding compound, wherein the control device is furthermore configured to control the movement device in such a way that the cavity is reduced in size by the relative movement while forming one or more thin-walled regions, wherein the one or more thin-walled regions have a material thickness of not more than 5 mm.

19. The device of claim 18, wherein the one or more thin-walled regions have a material thickness of not more than 3 mm.

20. The method of claim 7, wherein the one or more thin-walled regions have a material thickness of not more than 3 mm, and wherein the pressure acting on the hardenable molding compound is increased by not more than 10%.
